(19) United States
(12) Patent Application Publication
(10) Pub. No.: US 2005/0174297 A1
(43) Pub. Date: Aug. 11, 2005

(54) Compact ground-plane antenna

(76) Inventor: Brian Victor Cake, St. Augustine, FL (US)

Correspondence Address: FROMMER LAWRENCE & HAUG, 745 FIFTH AVENUE- 10TH FL., NEW YORK, NY, 10151, US

(21) Appl. No.: 11/030,411

(22) Filed: Jan. 6, 2005

Related U.S. Application Data
(60) Provisional application No. 60/544,041, filed on Feb. 9, 2004.

(51) Int. Cl. H01Q 9/26

(52) U.S. Cl. 343/834; 343/833

(57) ABSTRACT

Compact ground-plane antennas having a plurality of sub-elements disposed in a radially symmetric pattern above a ground-plane. Each sub-element is similarly shaped and has a total lenght of approximately one-quarter wavelength at the corresponding operating frequency. The present antennas exhibit a significant reduction in size and improved current sharing to permit better control of the antenna characteristics; in particular the antenna patterns and drive point impedance.

### CROSS-REFERNECE TO RELATED APPLICATIONS

This application claims the benefit of U.S. Provisional Application 60/544,041, filed Feb. 9, 2004; and incorporates herein by reference the entire contents of U.S. patent application Ser. No. 10/649,137, filed Aug. 26, 2003.

### FIELD OF THE INVENTION

The present invention relates generally to compact ground-plane antennas.

### BACKGROUND OF THE INVENTION

The half-wave dipole is a basic building block for many antennas. Typically, a half-wave dipole consists of a length of wire or tubing, fed at the center, which resonates at a frequency corresponding to a wavelength of twice the length of the dipole. For many applications, the physical length of a half-wave dipole is too great to be accommodated in the available space, and a great deal of research effort has been expended in finding ways of reducing antenna size without compromising performance. There are many techniques currently in use to reduce the size of an antenna element. The basic problems associated with short antenna elements are: 1) capacitive reactance that must be ‘tuned out’ in order for the element to accept power, 2) bandwidth is substantially reduced, and 3) radiation resistance is substantially lowered.

Additional background information relating to the design and use of physically small antennas can be found in the following exemplary prior art references. Some basic limits to the bandwidth and Q factor associated with small antennas are developed in Richard C. Johnson, “Antenna Engineering Handbook.” (Third Edition, McGraw-Hill, Inc., New York) Small antennas and their limitations are discussed in John D. Kraus, “Antennas,” (Second Edition, McGraw-Hill, Inc, New York, 1988) and in John A. Kuecken, “Antennas and Transmission Lines,” (First Edition, Howard W. Sams & Co. Inc, New York, 1969). Design problems and solutions for short antennas principally for use in hand-held radio communication devices are discussed in K. Fujimoto et al., “Small Antennas,” (John Wiley and Sons, Inc., New York 1987). U.S. Pat. No. 3,083,364 (to Scheldorf) discloses a helical monopole antenna of reduced physical size, designed to be used in conjunction with a ground plane, that incorporates a structure similar to that of a folded dipole that increases the feedpoint impedance such that, for example, a coaxial cable having a characteristic impedance of 50 ohms can be directly connected thereto.

A novel small antenna element having reasonable bandwidth, a low loss impedance transformation capability built in to its structure to allow direct connection to a feed cable, and the ability to be connected to other reduced size elements in order to provide multi-band operation without using switching or matching circuits is disclosed in related art U.S. patent application Ser. No. 10/649,137, entitled “Physically Small Antenna Elements and Antennas Based Thereon,” filed Aug. 26, 2003. (incorporated herein by reference) One of the disclosed embodiments applies this small antenna element to ground-plane antennas, where the antenna consists of a vertical radiating element above an extensive ground-plane.

The present invention is a further development of this concept of physically small ground-plane antennas. In particular, the present invention allows the use of vertical radiating elements and ground-plane structures that are significantly more compact than conventional ground-plane antennas.

### SUMMARY OF THE INVENTION

Accordingly, the present invention is directed to a compact ground-plane antenna comprising a plurality of similarly shaped elements. These elements improve upon the small antenna elements disclosed in U.S. patent application Ser. No. 10/649,137. These improved elements in turn allow for improvements to the ground plane antennas disclosed therein. The present invention is directed to improving current sharing to permit better control of the antenna characteristics; in particular the antenna pattern and drive point impedance. The present invention is also directed to reducing the antenna size while maintaining high performance.

The present antennas are easily connected to common transmission lines (having 50 ohm characteristic impedance) without the use of complex and expensive matching systems, as required by prior art antennas. Also, the present antennas substantially reduce both the height of the vertical radiator (by almost a factor of 5) and the extent of the required ground-plane (by almost a factor of 2). In addition, the present antennas allow for other antennas (e.g. for cell-phone and microwave link services) to be mounted on top of the supporting tower without complex and expensive isolation means which are often required by prior art antennas.

In a first embodiment of the invention, the ground-plane antenna comprises a plurality of sub-elements with each sub-element having a total length of approximately one-quarter wavelength at a corresponding operating frequency and having sequential first, second, and third sections. The first sections extend vertically upward from a horizontal ground-plane. The second sections are perpendicular to the first section such that the second section is substantially parallel to the ground-plane. The third section extends vertically downward toward the ground-plane, such that the third section is substantially parallel to the first section. An end of the third section forms a gap with the ground-plane that is a first fraction of the wavelength in length. A first sub-element of the plurality of sub-elements has a radio frequency source connected in series to a feed-point located on the first section proximate to the ground-plane. The plurality of sub-elements form a radially symmetric pattern wherein the first sections of each sub-element are positioned in parallel towards a center of the radial pattern and are spaced a second fraction of a wavelength apart. The second sections are equally-spaced and extend outward from the center. This causes the third sections to also be equally-spaced and vertically parallel along the outside of the radial pattern.

In a second embodiment of the invention, the second sections of the sub-elements of the ground-plane antenna in the first embodiment are comprised of sequential first and second sub-sections with the second sub-sections being bent at a predetermined angle in the horizontal plane from the first sub-sections.

In a third embodiment of invention, the ground-plane antenna comprises a plurality of sub-elements with each sub-element having a total length of approximately one-quarter wavelength at a corresponding operating frequency and having sequential first and second sections. The first section extends vertically upwards from a horizontal ground-plane. The second section comprising a plurality of serially connected sub-sections forming a horizontal meander pattern perpendicular to the first section, such that the second section is substantially parallel to the ground-plane. A first sub-element of the plurality of sub-elements has a radio frequency source connected in series to a feed-point located on the first section proximate to the ground-plane. The plurality of sub-elements form a radially symmetric pattern wherein the first sections of each sub-element are positioned in parallel towards a center of the radial pattern and are spaced a first fraction of a wavelength apart. The second sections are equally-spaced and extend outward from the center.

Other aspects of the invention include that the first sections of the plurality of sub-elements may be connected together at a location proximate to the second sections. The plurality of sub-elements may be conductors of wire, rod, tubing or printed circuit trace. The ground-plane may be a multi-wire radial system of conductors, each having a length of not more than one-quarter wavelength.

Still other objects and advantages of the invention will in part be obvious and will in part be apparent from the specification and the drawings.

### BRIEF DESCRIPTION OF THE DRAWINGS

For a more complete understanding of the invention, reference is made to the following description and accompanying drawings, in which:

FIG. 1 is a physically small dipole element antenna disclosed in related art U.S. patent application Ser. No. 10/649,137;

FIG. 2 is a ground-plane antenna version of the physically small dipole antenna shown in FIG. 1;

FIG. 3 is a ground-plane antenna based on a physically small dipole in accordance with a first embodiment of the present invention;

FIG. 4 is a ground-plane antenna with reduced horizontal size in accordance with a second embodiment of the present invention;

FIG. 5 is another ground-plane antenna with reduced horizontal size in accordance with a third embodiment of the present invention;

FIG. 6 shows the elevation radiation pattern for the antenna in FIG. 5; and

FIG. 7 is a plot of the SWR (standing wave ratio) for the antenna shown in FIG. 5.

### DETAILED DESCRIPTION OF THE PREFERRED EMBODIMENTS

The preferred embodiments of the apparatus and method according to the present invention will be described with reference to the accompanying drawings.

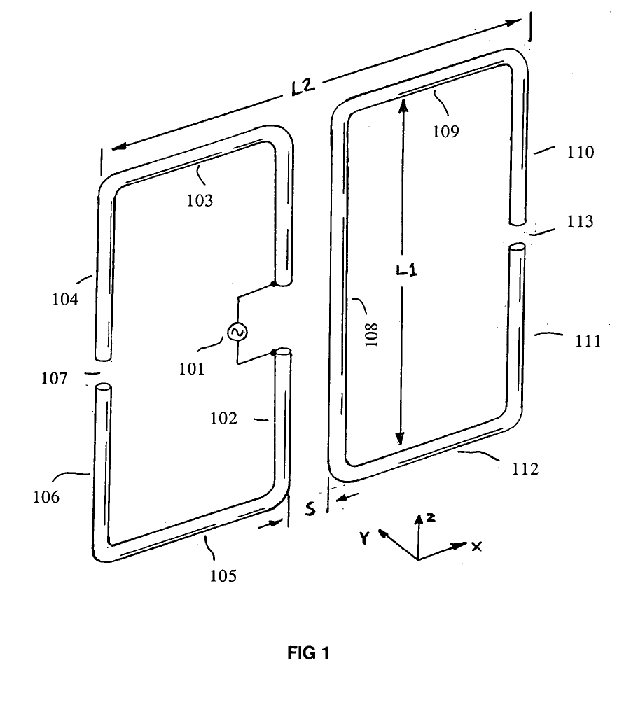

The present invention is based on variants of the short dipole antenna shown in FIG. 1. This dipole consists of two substantially identical sub-elements, each of which is formed from conductive wire, rod, tube or printed circuit trace, having a diameter or width of between approximately 0.0001λ and 0.01λ, where λ is the operating wavelength corresponding to the operating frequency. Each sub-element consists of a single conductive element, consisting of 102, 103, 104, 105 and 106 in the first sub-element, and 108, 109, 110, 111 and 112 in the second sub-element. The sub-elements are folded in the form shown in FIG. 1, such that there is a gap, 107, in the first sub-element, and 113 in the second sub-element, each gap being a small fraction of the total length of each sub-element. The first sub-element (the ‘driven’ sub-element), is driven by a radio frequency voltage source, 101, connected to the center of 102, either directly as shown or via a coaxial cable. It should be noted that, for clarity, the feed point in segment 102 of FIG. 1 is shown as being much wider than would be used in practice. The second sub-element (the ‘parasitic’ sub-element), is coupled to the driven sub-element principally via magnetic coupling between the close parallel sections, 102 and 108. The spacing, S, between 102 and 108 is less than approximately 0.05λ. The mutual inductive coupling is of a magnitude such that the two sub-elements are over-coupled and the combined sub-elements have two resonant frequencies, one above and one below the natural resonant frequency of each sub-element. At the lower resonant frequency, the currents in segments 102 and 108 are almost equal in amplitude and in phase. At the upper resonant frequency the currents in segments 102 and 108 are almost equal in amplitude and are in anti-phase. At the lower resonant frequency, the antenna behaves as a vertical radiator of high efficiency and having a feed point impedance of close to 50 ohms for the dimensions shown. This avoids the need for complex and expensive matching networks to drive the feed point from a 50 ohm transmission line.

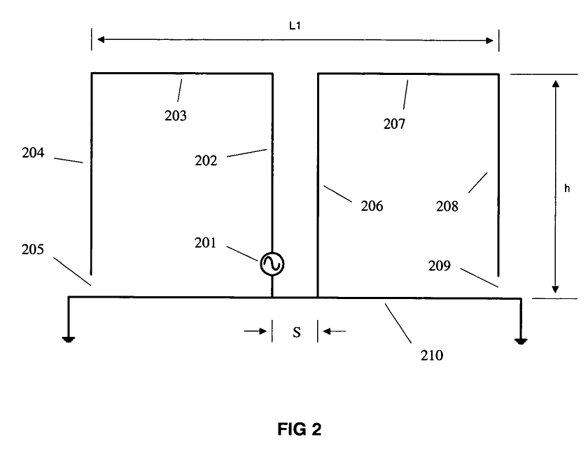

A ground-plane version of the antenna in FIG. 1 is shown in FIG. 2. Here the source of radio frequency voltage, 201, is connected between a high-conductivity ground-plane, 210, and a first sub-element consisting of segments 202, 203, and 204. A gap, 205, exists between the lower end of segment 204 and the ground-plane. The second sub-element consists of segments 206, 207 and 208, with a second gap, 209, between the lower end of segment 208 and the ground-plane. The length L1 is approximately

$$\frac{λ}{6}$$

long and the height h is approximately

$$\frac{λ}{12} .$$

Segments 202 and 206 are spaced by a distance S, which is less than approximately 0.05λ, and are principally magnetically coupled. This ground-plane antenna behaves similarly to the antenna described in FIG. 1 with the primary difference being the drive-point impedance is now one-half of 50 ohms; or 25 ohms. The drive-point impedance may be raised either by increasing the height h, and reducing the length L1 to maintain a total sub-element length of

$$\frac{λ}{4} ,$$

or by adding one or more sub-elements also coupled magnetically; or by a combination of these approaches. Increasing the height, h, increases the radiation resistance of each sub-element and thus raises the feed point resistance. Coupling one or more additional sub-elements to this two sub-element antenna increases the feed point resistance because the feed-point resistance increases roughly in proportional to the square of n, where n is the number of sub-elements.

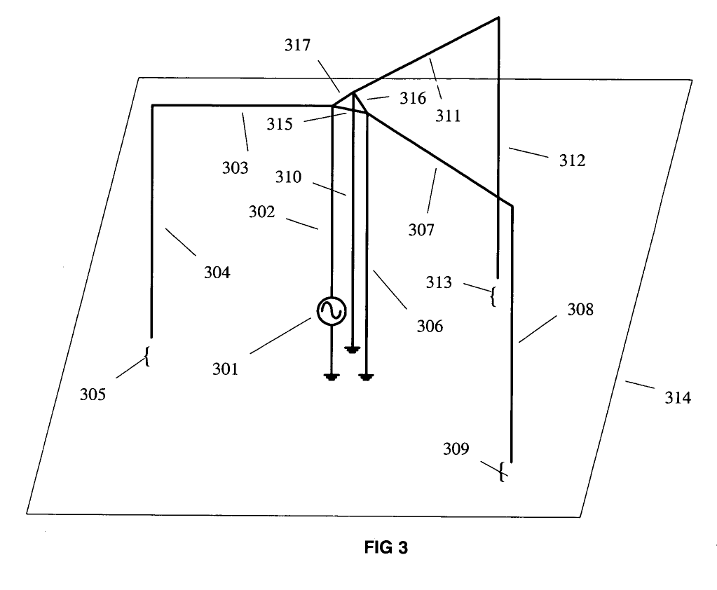

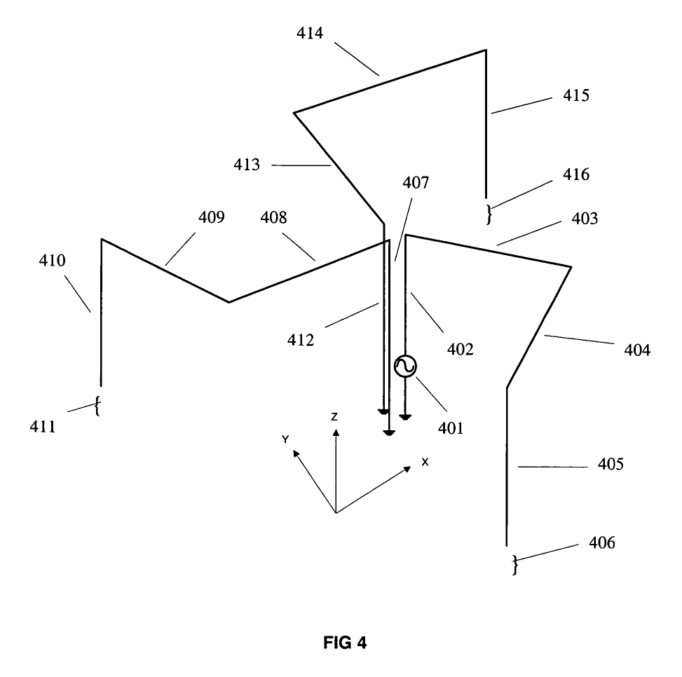

However, the currents in the sub-elements shown in FIG. 2 are not precisely in phase and of equal amplitude, so for applications where operation at the upper resonant frequency is not required an improvement in amplitude and phase balance of the currents in the vertical segments of the sub-elements may be achieved by modifying the antenna as shown in FIG. 3. FIG. 3 shows a ground-plane antenna having three sub-elements in accordance with a first embodiment of the present invention. A source of radio frequency voltage is connected between segment 302 of the driven sub-element and the ground-plane. Segments 303 and 304 and the gap 305 form the rest of the driven sub-element. Two sub-elements, consisting of segments 306, 307 and 308 and the gap, 309 in the first coupled sub-element, and segments 310, 311, and 312 and the gap 313 in the second coupled sub-element, are coupled to the driven sub-element. The tops of segments 302, 306, and 310 are joined together by conductors 315, 316 and 317. These top connections, although prohibiting use of the antenna at the upper resonant frequency, equalize the currents in the vertical segments 302, 306 and 310, improve the omni-directional pattern and provide better control of the drive-point resistance. In some circumstances it may be desirable to reduce the total horizontal extent of the ground-plane shown in FIG. 3. This is particularly true for broadcast antennas in the medium frequency band from about 500 kHz to 1.5 MHz, where land costs are a major consideration. This horizontal extent may be reduced by increasing the height of the ground-plane, but taller antenna masts are also more expensive. FIG. 4 shows one method for achieving this goal by changing the arrangement of the horizontal segments of the antenna shown in FIG. 3 in accordance with a second embodiment of the present invention. In FIG. 4, the source of radio frequency voltage, 401, is connected between a ground-plane (not shown for clarity) and the driven vertical section, 402, of the driven sub-element that consists of sections 402, 403, 404 and 405. A small gap, 406, exists between the outer vertical section, 405, and the ground plane. The first coupled sub-element consists of sections 407, 408, 409, 410, and the gap 411, and the second coupled sub-element consists of sections 412, 413, 414, 415 and the gap 416. Note that the antenna may or may not have the tops of sections 402, 407, and 412 connected, depending on the application. The antenna theory shows that the performance is not disturbed provided that the capacitive coupling between the horizontal segments in FIG. 3, and also between the outer vertical segments in FIG. 3, is maintained at a low value. In FIG. 4 this is achieved by bending the horizontal segments as shown. For example, horizontal segments 404, 409, and 414 are each bent in plane at the same angle from horizontal segments 403, 408, and 413, respectively. The impedance multiplying capability and the low loss characteristics of the antenna of FIG. 3 are maintained, and the only impact of the change in shape is a reduction in the antenna operating bandwidth, as is expected from considerations of the effective diameter of the antenna. This approach for reducing the antenna diameter, as shown in FIG. 4, is not the only possible approach. As another example, the horizontal segments may be formed into a spiral, a meandering pattern, or any other shape provided that the horizontal segments are spaced as far apart from each other as possible for a given antenna diameter.

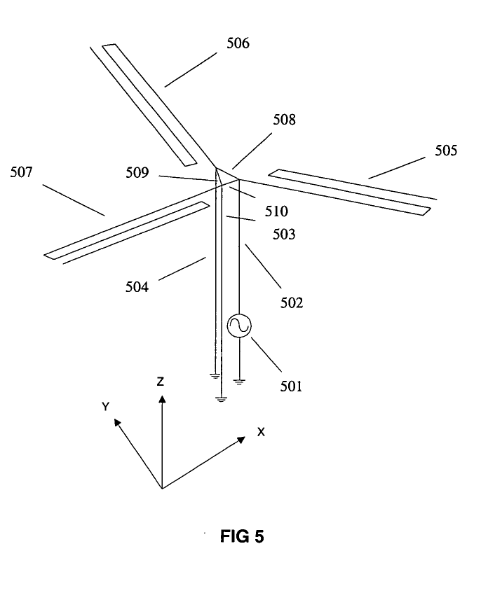

FIG. 5 shows an example of the use of a “meander” pattern configuration for the horizontal elements in accordance with a third embodiment of the present invention. Sections 502, 503 and 504 form the 3 vertical sub-elements, with a source of radio frequency voltage in series with 502 at the grounded end thereof. The lower ends of sub-elements 503 and 504 are connected directly to ground, or a ground-plane consisting of many buried wires as is conventionally used by medium frequency broadcast antennas. The horizontal loading wires, 505, 506, and 507 are connected to the tops of sub-elements 502, 503 and 504 respectively. Each of these loading wires 505, 506 and 507 is bent into a “meander” shape as shown in FIG. 5. In this example, the tops of the sub-elements 502, 503 and 504 are connected by wires 508, 509 and 510. In an antenna for broadcasting at 1 MHz the sub-elements 502, 503 and 504 are each 53 feet tall and are equally-spaced around a 9 foot diameter circle. The meander pattern loading lines 505, 506 and 507 each consists of wires having a total length of 201 feet folded into a meander pattern having a length of 67 feet, each wire being spaced 8 feet from the next adjacent wire. For this antenna the ground-plane consists of 120 radial wires buried 20 inches below ground, each radial wire having a length of 110 feet. For conventional quarter-wavelength-high broadcast antennas operating at 1 MHz the ground plane consists of 120 buried radial wires with a length of one-quarter wavelength, or 250 feet. This reduction in the area required for the disclosed antenna significantly reduces both ground-plane and real estate cost.

Those skilled in the art will recognize that the ground-plane antenna illustrated in FIG. 5 may be modified in many ways without affecting the principle of operation. For example, the individual wires that comprise the meander pattern loading lines 505, 506 and 507 need not be co-planar, nor do they need to be horizontally distributed and parallel to the ground-plane. Each of the meander pattern loading lines may be dressed upwards or downwards away from the vertical wires 502, 503 and 504, such that the angle between the meander pattern loading lines 505, 506 and 507, and the vertical wires 502, 503 and 504, is less than or greater than 90 degrees.

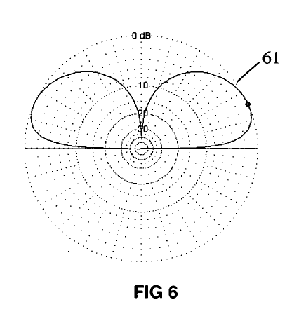

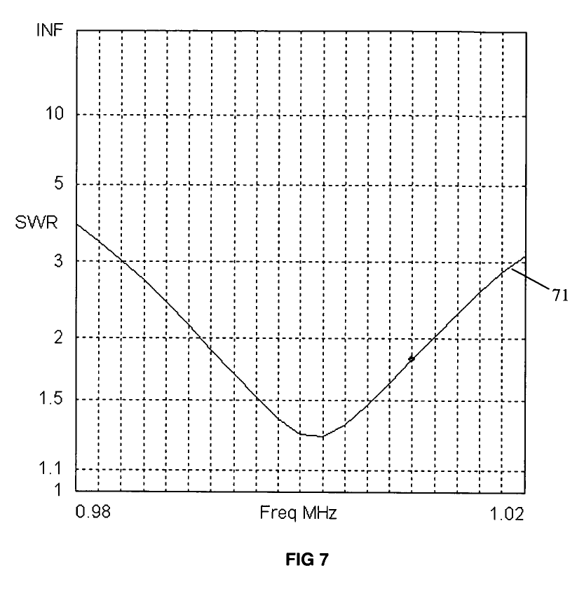

The simulated performance of a ground-plane antenna according to FIG. 5, is shown in FIGS. 6 and 7. The simulation included all known loss mechanisms. FIG. 6 shows the elevation pattern 61, and FIG. 7 a plot of the standing wave ratio (SWR) 71 in a 50 ohm system. The SWR plot is a direct measure of the SWR at the feed point and does not use any other matching systems.

It should be noted that two of the vertical sub-elements in the present antennas have their lower ends connected directly to ground. This allows other service antennas, such as cell phone and microwave link antennas to be mounted at the top of the vertical wire supports without having to isolate their feed cables at ground level and so reduces the cost of mounting those antennas.

It can be seen that the present antennas exhibit very desirable features that are unique for such a small antenna. The examples given above are by no means exhaustive and should not be construed to limit the invention in any way.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

1. A ground-plane antenna, comprising:
a plurality of sub-elements, each sub-element having a total length of approximately one-quarter wavelength at a corresponding operating frequency and comprising sequential first, second, and third sections; said first section extending vertically upward from a horizontal ground-plane; said second section being perpendicular to the first section, whereby the second section is substantially parallel to the ground-plane; said third section extending vertically downward toward the ground-plane, whereby the third section is substantially parallel to the first section; an end of the third section forming a gap with the ground-plane a first fraction of the wavelength in length;
wherein a first sub-element of said plurality of sub-elements has a radio frequency source connected in series to a feed-point located on the first section proximate to the ground-plane; and
said plurality of sub-elements forming a radially symmetric pattern wherein said first sections of each sub-element are positioned in parallel towards a center of the radial pattern and spaced a second fraction of a wavelength apart; said second sections being equally-spaced and extending outward from the center, whereby the third sections are equally-spaced and vertically parallel along the outside of the radial pattern.

2. The ground-plane antenna according to claim 1, wherein the first sections of said plurality of sub-elements are connected together at a location proximate to the second sections.

3. The ground-plane antenna according to claim 1, wherein said second sections are comprised of sequential first and second sub-sections; the second sub-sections being bent at a predetermined angle in the horizontal plane from the first sub-sections.

4. The ground-plane antenna according to claim 1, wherein the plurality of sub-elements are conductors of wire, rod, tubing or printed circuit trace.

5. The ground-plane antenna according to claim 1, wherein said ground-plane is a multi-wire radial system of conductors, each having a length of not more than one-quarter wavelength.

6. A ground-plane antenna, comprising:
a plurality of sub-elements, each sub-element having a total length of approximately one-quarter wavelength at a corresponding operating frequency and comprising sequential first and second sections; said first section extending vertically upwards from a horizontal ground-plane; said second section comprising a plurality of serially connected sub-sections forming a meander pattern at a predetermined angle from the first section;
wherein a first sub-element of said plurality of sub-elements has a radio frequency source connected in series to a feed-point located on the first section proximate to the ground-plane; and
said plurality of sub-elements forming a radially symmetric pattern wherein said first sections of each sub-element are positioned in parallel towards a center of the radial pattern and spaced a first fraction of a wavelength apart; said second sections being equally spaced and extending outward from the center.

7. The ground-plane antenna according to claim 6, wherein said plurality of serially connected sub-sections form a horizontal meander pattern perpendicular to the first section, whereby the second section is substantially parallel to the ground-plane;

8. The ground-plane antenna according to claim 6, wherein the first sections of said plurality of sub-elements are connected together at a location proximate to the second sections.

9. The ground-plane antenna according to claim 6, wherein the plurality of sub-elements are conductors of wire, rod, tubing or printed circuit trace.

10. The ground-plane antenna according to claim 6, wherein said ground-plane is a multi-wire radial system of conductors, each having a length of not more than one-quarter wavelength.
